(19) United States
(12) Patent Application Publication
(10) Pub. No.: US 2002/0169891 A1
(43) Pub. Date: Nov. 14, 2002

(54) Web address conversion system and Web address conversion method

(75) Inventors: Koji Sasaki, Kyoto (JP); Shosuke Sasaki, Kyoto (JP); Ryuji Yukawa, Kyoto (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: J-DATA CO., LTD., Kyoto (JP)

(21) Appl. No.: 10/139,349

(22) Filed: May 7, 2002

(30) Foreign Application Priority Data
May 9, 2001 (JP) 2001-138491

(51) Int. Cl. G06F 15/16

(52) U.S. Cl. 709/245; 709/219; 709/246

(57) ABSTRACT

An assignment server which receives access from a browser installed in a user terminal includes a terminal attribute specifying element for specifying an attribute of the user terminal from which access is made (or a country to which the user terminal belongs), and an assignment element for changing a destination to which the browser is to be connected to a conversion server corresponding to the attribute of the user terminal. The conversion server holds therein a conversion table produced in corresponding relation to the attribute of the user terminal and containing an identification number and a Web page address of Web content associated with each other. On receipt of a search request designating the identification number, the conversion server sends a response designating the corresponding Web page address. Thus, desired Web content is displayed in the browser. This provides a system capable of reducing the cumbersome input operation of a user that makes Web access to allow the user to easily browse information.

### BACKGROUND OF THE INVENTION

1. Field of the Invention

The present invention relates to the configuration of a system that supports Web access using an identification number.

2. Description of the Background Art

Web access using a portable or mobile telephone has been made very often lately. As the Internet becomes widespread rapidly, numerous pieces of Web content are produced in various countries of the world. Of the numerous pieces of Web content, there are many pieces of Web content compliant with browsers installed in portable telephones. Different Web page addresses such as URLs (Uniform Resource Locators) are assigned respectively to the pieces of Web content compliant with browsers installed in portable telephones.

In general, to access a desired Web page by determining a Web site, a user specifies a Web page address in a browser of his/her portable telephone. The browser accesses Web content corresponding to the inputted Web page address, and displays obtained information. Ordinary users need a somewhat limited range of Web content. For example, it is often sufficient for Japanese users to be able to access Web content for Japan.

However, a normal Web page address has a long character string comprised of alphanumeric characters and symbols, and it is cumbersome for a user to enter the character string of the Web page address in the browser. In particular, a compact portable terminal, such as a portable telephone, has small key-in buttons arranged in closely spaced relation, which makes it very cumbersome for the user to enter a long character string.

### SUMMARY OF THE INVENTION

The present invention is intended for a Web address conversion system for performing a Web address conversion process corresponding to an attribute of a terminal.

According to the present invention, the Web address conversion system comprises: a specifying element for specifying an attribute of a terminal from which access is made upon receipt of an access request from the terminal; a table holding element for holding therein a conversion table produced in corresponding relation to the attribute of the terminal, the conversion table containing an identification number and a Web page address of Web content associated with each other; and a conversion element, upon receipt of an access request designating the identification number from the terminal, for searching the conversion table corresponding to the attribute of the terminal specified by the specifying element to retrieve for a Web page address associated with the identification number, thereby sending a response designating the retrieved Web page address to the terminal from which access is made.

A user can easily browse necessary information only by designating the identification number without any cumbersome input operation. Additionally, searching only the necessary conversion table improves search efficiency.

According to another aspect of the present invention, a Web address conversion system for performing a Web address conversion process corresponding to an attribute of a portable telephone comprises: a specifying element for specifying an attribute of a portable telephone from which access is made upon receipt of a Web access request from the portable telephone; a table holding element for holding therein a conversion table produced in corresponding relation to the attribute of the portable telephone, the conversion table containing an identification number and a Web page address of Web content associated with each other; and a conversion element, upon receipt of an access request designating the identification number from the portable telephone, for searching the conversion table corresponding to the attribute of the portable telephone specified by the specifying element to retrieve a Web page address associated with the identification number, thereby sending a response designating the retrieved Web page address to the portable telephone from which access is made.

In particular, a user of the portable telephone can easily browse necessary information only by designating the identification number without any cumbersome input operation. Additionally, searching only the necessary conversion table improves search efficiency.

The present invention is also intended for a method of performing a Web address conversion process corresponding to an attribute of a portable telephone.

It is therefore an object of the present invention to provide a system capable of reducing the cumbersome input operation of a user that makes Web access to allow the user to easily browse information.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall configuration of a Web address conversion system according to one preferred embodiment of the present invention;

FIG. 2 is a block diagram of the Web address conversion system;

FIGS. 3A, 3B, and 3C are views showing a display state transition of a user terminal when the Web address conversion system is used;

FIG. 4 shows an example of conversion tables included in a conversion server for Japan; and

FIG. 5 shows an example of conversion tables included in a conversion server for the U.S.

### DESCRIPTION OF THE PREFERRED EMBODIMENT

A preferred embodiment according to the present invention will now be described with reference to the drawings.

1. System Configuration

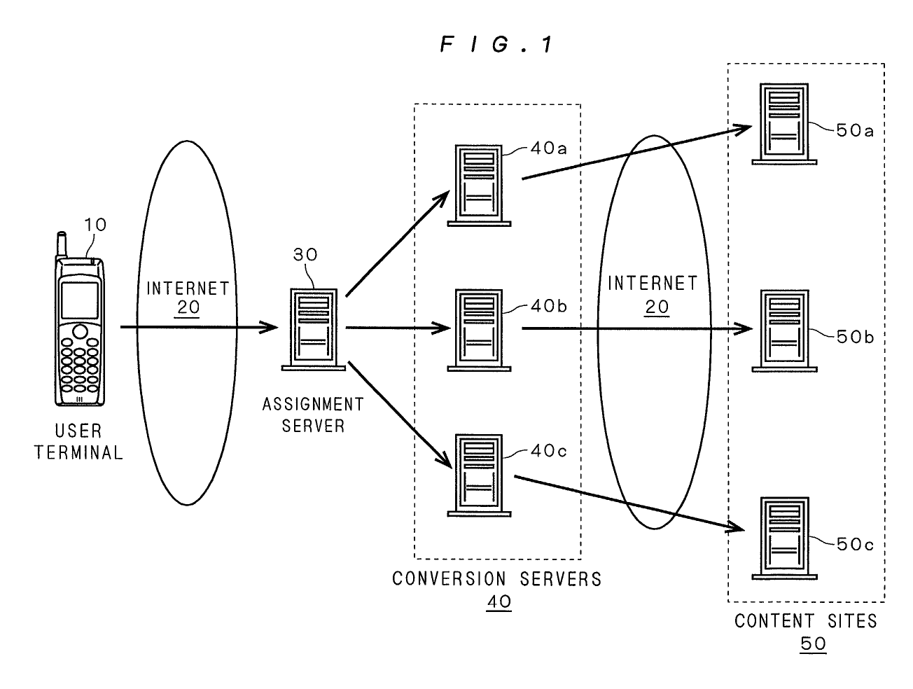

With reference to FIG. 1, the overall configuration of a Web address conversion system according to the preferred embodiment will be described below. The Web address conversion system provides a Web address conversion service in response to a request from a user terminal 10 which is one of network terminals or communication devices making use of the system. The user terminal 10 can easily access Web content provided at content sites 50 (50a, 50b and 50c) by the use of the system.

The Web address conversion system comprises an assignment server 30 and conversion servers 40. The conversion servers 40 include three conversion servers 40a, 40b and 40c corresponding to attributes of user terminals (portable telephones) 10.

In this preferred embodiment, the three conversion servers 40a, 40b and 40c are provided in corresponding relation to countries to which portable telephones belong. More specifically, the three conversion servers 40a, 40b and 40c correspond to Japan, the U.S. and the ROK (South Korea), respectively. The term “a country to which a portable telephone belongs” as used herein denotes a country in which the language used by the portable telephone is a native language. For example, a portable telephone belonging to Japan denotes a portable telephone which uses Japanese as a language.

The plurality of content sites 50 include content sites 50a, 50b and 50c possessing Web content provided for portable telephones for Japan, the U.S. and the ROK, respectively. For example, the content sites 50a, 50b and 50c possess Web content produced for Japanese, American and South Korean users, respectively.

For purposes of simplicity, the preferred embodiment shows an example in which the individual content sites possess Web content for respectively different countries. However, even if a single content site possesses Web content for a plurality of countries, the Web address conversion system of the preferred embodiment produces similar effects without any problem.

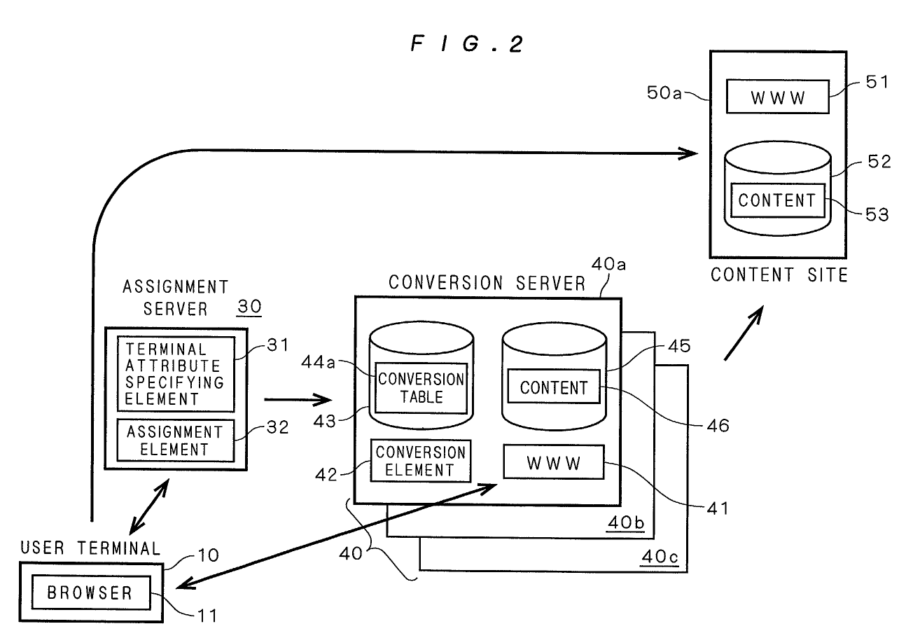

Referring to FIG. 2, the user terminal 10 in this preferred embodiment is a portable telephone containing a Web-accessible browser 11.

The content site 50a has a WWW server application 51 (hereinafter referred to as a “WWW 51”), and posts Web content 53 for Japan stored in a storage device 52 on the Internet 20.

In this preferred embodiment, the user terminal (portable telephone) 10 is a portable telephone belonging to Japan, and allows a user to browse the Web content 53 at the content site 50a by the use of the browser 11. The content sites 50b and 50c are similar in configuration to the content site 50a except that Web content 53 at the content sites 50b and 50c is for the U.S. and the ROK, respectively.

The assignment server 30 comprises a terminal attribute specifying element 31 and an assignment element 32. The terminal attribute specifying element 31 is an element for judging the attribute of a portable telephone from which access is made, that is, the country to which the portable telephone belongs in this preferred embodiment. More specifically, the terminal attribute specifying element 31 determines which country the portable telephone or user terminal 10 belongs to, from the language used by the portable telephone from which access is made. This determines the attribute of the portable telephone (or the country to which the portable telephone belongs to).

The assignment element 32 sends a response designating the Web page address (e.g., URL) of a corresponding one of the conversion servers 40, depending on the country to which the user terminal 10 from which access is made belongs. Specifically, when the terminal attribute specifying element 31 determines the country to which the user terminal 10 belongs, the assignment element 32 returns to the browser 1 the Web page of one of the conversion servers 40 corresponding to the country to which the user terminal 10 belongs. In the instance shown in FIG. 2, if the user terminal 10 is a portable telephone belonging to Japan and the terminal attribute specifying element 31 determines that the country to which the user terminal 10 belongs is Japan, the assignment element 32 returns to the browser 11 the Web page of the conversion server 40a for Japan. Similarly, if the user terminal 10 belongs to the U.S. or the ROK, the destination server to which connection is to be established is changed to the conversion server 40b or 40c, respectively.

The conversion servers 40 (40a, 40b and 40c) provide a service that converts an identification number to be described later into a corresponding Web page address and sends a response designating this Web page address to the browser 11 on receipt of an access request designating the identification number from the browser 11 of the user terminal 10. In this preferred embodiment, as discussed above, the three conversion servers 40a, 40b and 40c are provided in corresponding relation to the countries (Japan, the U.S. and the ROK in this preferred embodiment) to which the user terminals (portable telephones) 10 belong.

The configuration of the conversion server 40a will be described as an example of the conversion servers 40. The conversion servers 40b and 40c are substantially similar in configuration to the conversion server 40a, but differ in data entered in a conversion table and the contents of Web content.

Referring again to FIG. 2, the conversion server 40a includes a WWW server application 41 (hereinafter referred to as a “WWW 41”), and posts Web content 46 stored in a storage device 45 on the Internet 20. Thus, the conversion server 40a has the function serving as a conventional Web site. The Web content 46 provided in the conversion server 40a is produced for Japanese users. Similarly, Web content 46 provided in the conversion servers 40b and 40c is produced for American and South Korean users, respectively.

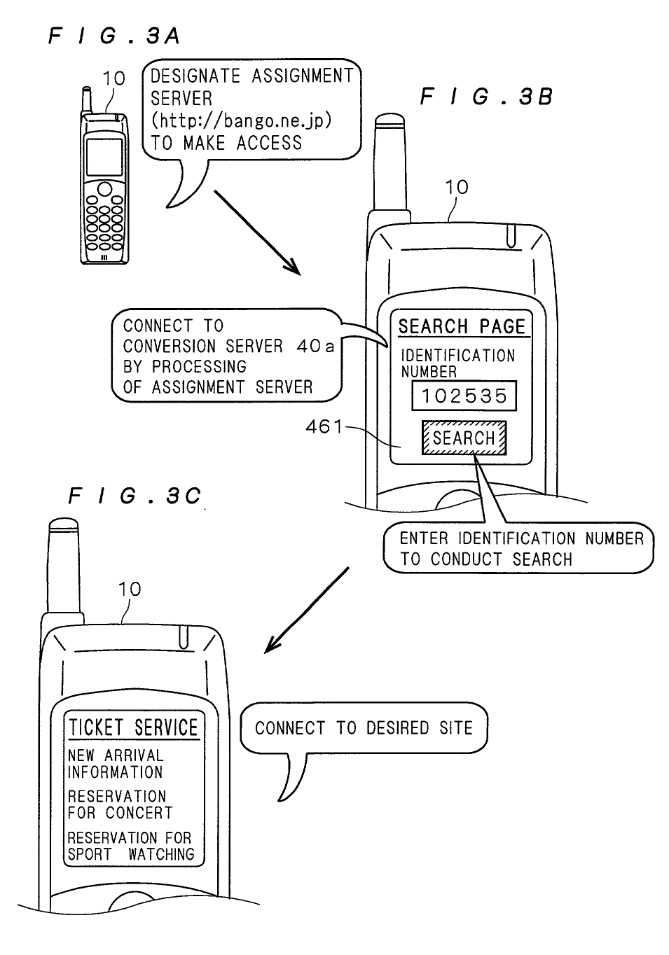

The Web content 46 includes a search page 461 for providing an identification number search service to the user. FIG. 3B shows an example of the search page 461 as displayed on a monitor of a portable telephone. The search page 461 is content including an identification number input form and a search execution object. The user can first access the search page 461 and then perform a search operation using an identification number.

The conversion server 40a further includes a conversion element 42 and a storage device 43 for holding a Web address conversion table 44a therein.

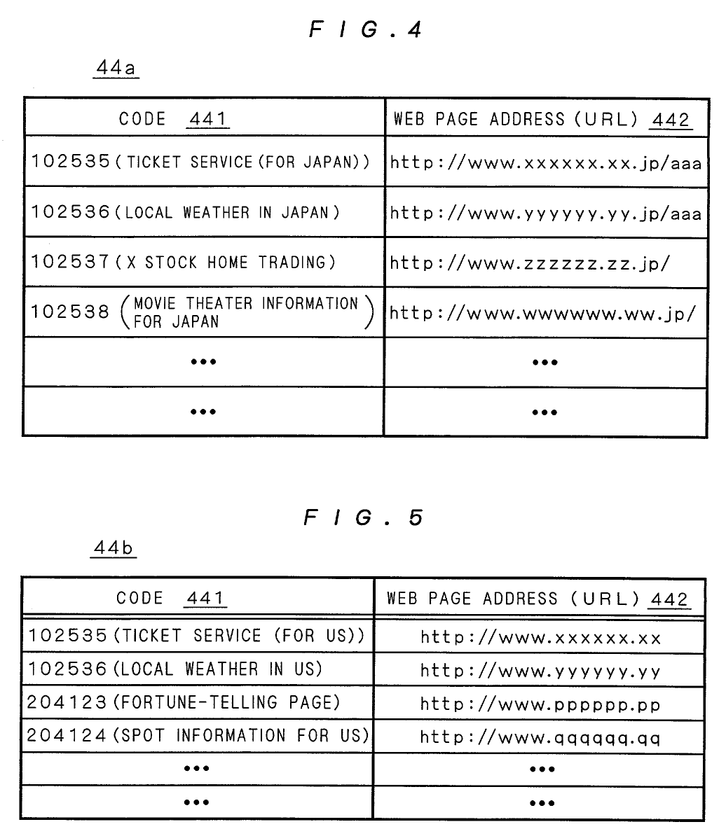

FIG. 4 shows an example of the Web address conversion table 44a. The Web address conversion table 44a is a database containing an identification number (code) 441 associated with each Web page address (URL) 442 of Web content. The Web content at the Web page address (URL) 442 is Web content 53 for Japan stored in the content site 50a.

The identification number 441 is a 6-digit numerical character code, as illustrated in FIG. 4. The individual code is shown in FIG. 4 as accompanied by the description of a home page corresponding to the code (identification number 441) for purposes of convenience. Although the 6-digit number is used as the identification number 441 in this preferred embodiment, the identification number 441 may include other characters and symbols. Although no particular limitation is imposed on the number of digits, the number of digits is preferably not so high for purposes of eliminating the cumbersomeness of the entry of the identification number 441.

The Web address conversion table 44a is a database for Japan in which stored are codes for home pages, for example, for a ticket service for Japan, weather information and movie theater information for Japan. Thus, all of the Web page addresses 442 stored in the Web address conversion table 44a are those corresponding to the Web content (stored in the content site 50a) produced for Japanese users.

Likewise, a Web address conversion table 44b which is a database for the U.S. is held in the storage device 43 of the conversion server 40b for the U.S. FIG. 5 shows an example of the Web address conversion table 44b. The Web address conversion table 44b is similar to the Web address conversion table 44a in that an identification number (code) 441 is associated with each Web page address (URL) 442. However, the Web address conversion table 44b is the database for the U.S. in which stored are codes for home pages, for example, for a ticket service for the U.S., weather information and spot information for the U.S. Thus, all of the Web page addresses 442 stored in the Web address conversion table 44b are those corresponding to the Web content (stored in the content site 50b) produced for American users.

Similarly, a Web address conversion table which is a database for the ROK is held in the storage device 43 of the conversion server 40c for the ROK. In the Web address conversion table, an identification number (code) is associated with each Web page address (URL) of Web content for the ROK stored in the content site 50c.

Thus, the Web address conversion table which is the database in which the identification number (code) 441 and the Web page address (URL) 442 are associated with each other is produced in corresponding relation to the attribute of the user terminal (portable telephone) 10 or, more specifically, is produced for each country to which the user terminal 10 belongs.

Referring again to FIG. 2, the conversion element 42 is called from the above-mentioned search page 461 to execute a search process in the background of the WWW 41. The conversion element 42 has a link function with the database. Using an identification number 441 designated on the search page 461 as key information, the conversion element 42 searches the conversion table 44a to retrieve a corresponding Web page address 442.

After the retrieval of the Web page address 442, the conversion element 42 defines the retrieved Web page address 442 as a destination to which the browser 11 of the user terminal 10 is to be linked. As a result, the Web content corresponding to the Web page address 442 is displayed in the browser 11. For instance, when the destination to which the browser 11 of the user terminal 10 is to be linked is Web content at the Web site 50a, content included in the Web content 53 is displayed in the browser 11.

The conversion servers 40 execute the foregoing processing to provide the search service for the identification number 441 to the user.

2. Process Flow

A process flow of the Web address conversion system configured as discussed above will be described with reference to FIGS. 3A, 3B, and 3C.

Referring now to FIG. 3A, the user performs a predetermined keying operation on the user terminal 10 to access the assignment server 30.

The term “predetermined keying operation” used herein means the operation of connecting to the Internet in accordance with portable telephones and the operation of specifying a Web address for the assignment server 30. The process for specifying a Web address for the assignment server 30 includes directly entering a Web page address (e.g., “http://bango.ne.jp”), and temporarily making a connection to another site from which a link, if any, is provided to specify a link from the site.

Saving the Web page address, for example, as a “bookmark” eliminates the need to specify the Web address for the assignment server 30 when making the second and subsequent accesses, which will be described later.

The operation of specifying the Web address for the assignment server 30 causes the browser 11 of the user terminal 10 to access the assignment server 30. On receipt of an access request from the browser 11, the terminal attribute specifying element 31 in the assignment server 30 checks up on the language used in the user terminal 10 from which access is made to determine the attribute of the user terminal 10, i.e., the country to which the user terminal 10 or the portable telephone belongs. In this instance, the user terminal 10 is a portable telephone belonging to Japan, and the terminal attribute specifying element 31 determines that the portable telephone from which access is made belongs to Japan. Then, the assignment element 32 specifies the Web page address of a conversion server corresponding to the attribute of the portable telephone determined by the terminal attribute specifying element 31. Specifically, the assignment element 32 sends a response designating the Web page address of the conversion server 40a for Japan, and the destination to which the browser 11 of the user terminal 10 is to be linked is changed to the conversion server 40a. Then, the search page 461 of the conversion server 40a is displayed in the browser 11, as shown in FIG. 3B.

Next, the user enters the identification number of desired Web content on the search page 461. The user can obtain in advance the identification number of the desired Web content from a magazine, an advertisement, or the Internet. The identification number thus obtained is, for example, a 6-digit number, as in this preferred embodiment. This facilitates making a note of the identification number, unlike a long Web page address character string. This also facilitates the operation of entering the identification number while viewing the magazine or advertisement. In FIG. 3B, the identification number “102535” is shown as entered.

When the identification number “102535” is entered on the search page 461 to provide an instruction to conduct a search, the conversion element 42 in the conversion server 40a performs a Web page address search process. Specifically, using the obtained identification number (code) 441 as a search key, the conversion element 42 searches the Web address conversion table 44a for Japan shown in FIG. 4 to retrieve the Web page address (URL) 442 corresponding to the identification number 441. In this instance, the Web page address “http://www.xxxxxx.xxjp/aaa” corresponding to the identification number “102535” is retrieved.

After the retrieval of the Web page address 442 corresponding to the identification number 441, the conversion element 42 changes the destination to which the browser 11 is to be linked to the retrieved Web page address. In this instance, the Web page address “http://www.xxxxxx.xxjp/aaa” indicates a home page for a ticket service (for Japan), and a Web page for the ticket service (for Japan) is displayed in the browser 11 of the user terminal 10, as shown in FIG. 3C.

In this manner, the user of the user terminal 10 who makes Web access is required only to enter the identification number composed of the 6-digit number or the like to refer to the desired Web content, thereby easily browsing information. That is, the user who makes Web access can easily browse information without cumbersome input operation.

If the user terminal 10 is a Japanese terminal, the Web address conversion table 44a for Japan is searched for retrieval of a desired Web page address. This eliminates the need to search unnecessary Web pages (e.g., home pages for foreign countries), thereby to improve search efficiency.

Each browser has the function of saving a site visited once by the user (e.g., a “favorites” or “bookmark” function). When visiting again the same content site, the user can use this function to omit the entry of the Web page address.

When access is made to the assignment server 30, the user terminal 10 is connected to the conversion server 40a by automatic execution of the assignment element 32 (the state shown in FIG. 3B). That is, when the user accesses the assignment server 30 and then bookmarks the Web page address, the Web page address of the conversion server 40a is saved as the bookmark. Therefore, when making the second and subsequent accesses, the user can designate the Web page address using the bookmark to connect the user terminal 10 directly to the conversion server 40a. Thus, when making the second and subsequent accesses, the user is merely required to access the conversion server 40a by the designation using the bookmark, and then to enter an identification number to execute the search operation. This completely eliminates the need for the user to cumbersomely enter any character.

Although the instance wherein the user terminal 10 is the portable telephone belonging to Japan is described above, the process flow is exactly the same for a user terminal 10 which is a portable telephone belonging to other countries. In this case, the assignment element 32 connects the user terminal 10 to the conversion server 40b for the U.S. or to the conversion server 40c for the ROK, and thereafter the same process as described above is performed.

3. Access to Other Conversion Servers

In this preferred embodiment, the user terminal 10 from which access is made is automatically connected to the corresponding one of the conversion servers 40 depending on the country to which the user terminal 10 belongs, as described above. However, there are occasions when the user wishes to connect the user terminal 10 to a different one of the conversion servers 40. For instance, although a Japanese portable telephone is normally connected to the conversion server 40a for Japan, there may be cases where a Japanese portable telephone user wishes to connect the user terminal 10 to the conversion server 40b for the U.S. to browse or view a home page for the U.S.

In such cases, the user enters the identification number with an additional symbol on the search page 461. For example, a Japanese portable telephone is connected to the conversion server 40a for Japan by the assignment element 32, unless otherwise specified. The user may enter “US#102535” on the search page 461 of the conversion server 40a displayed in the user terminal 10. Of the entered characters “US#102535,” the characters US#” represent the additional symbol, and the characters “102535” represent the identification number.

When the identification number with the additional symbol, such as “US#102535,” is specified at the user terminal (portable telephone) 10, the conversion element 42 in the conversion server 40b for the U.S. performs the Web page address search process. The additional symbol “US#” corresponds to the conversion server 40b for the U.S. When the identification number “102535” with the additional symbol “US#” is specified, the conversion server 40a passes the identification number “102535” as a search key to the conversion server 40b for the U.S., and the conversion element 42 in the conversion server 40b searches the Web address conversion table 44b for the U.S. shown in FIG. 5. Then, a Web page address “http://www.xxxxxx.xx” corresponding to the identification number “102535” is retrieved.

Upon retrieving the Web page address “http://www.xxxxxx.xx” corresponding to the identification number “102535,” the conversion element 42 in the conversion server 40b changes the destination to which the browser 11 is to be linked to this Web page address. In this instance, the Web page address “http://www.xxxxxx.xx” indicates a home page for a ticket service (for the U.S.), and a Web page for the ticket service (for the U.S.) is displayed in the browser 11 of the user terminal 10.

In this manner, the user can connect the user terminal 10 to the different one of the conversion servers 40 without difficulty only by adding the simple additional symbol to the identification number. A Japanese portable telephone user, for example, can easily browse information for the U.S. by the use of the Web address conversion table 44b for the U.S.

Just as the additional symbol “US#” is associated with the conversion server 40b for the U.S., the additional symbols “JP#” and “KR#” may be associated with the conversion servers 40a and 40b for Japan and the ROK, respectively, so that the above-mentioned operation is performed.

4. Modifications

Although the preferred embodiment according to the present invention is described above, the present invention is not limited to this. For example, although the conversion servers 40a, 40b and 40c in the preferred embodiment are configured separately from each other as shown in FIGS. 1 and 2, these conversion servers 40a, 40b and 40c may be implemented in a single server (hardware). Alternatively, the conversion servers 40a, 40b, 40c and the assignment server 30 may be implemented in a single server. However, even if the conversion servers 40a, 40b and 40c are implemented in a single server, it is necessary that the Web address conversion tables or databases in which the identification number 441 and the Web page address 442 are associated with each other are produced in respectively corresponding relation to the attributes of the user terminals (portable telephones) 10. This allows the use of the same identification number (e.g., the identification number “102535” in the above case) for different Web page addresses in the respective Web address conversion tables.

In the preferred embodiment, the three Web address conversion tables for Japan, the U.S. and the ROK are produced. However, the Web address conversion tables may be produced for other countries (e.g., Germany, France and others). Further, the Web address conversion tables may be produced for two or more countries.

In the preferred embodiment, the terminal attribute specifying element 31 checks up on the language used in the user terminal 10 from which access is made to determine the attribute of the user terminal 10. The present invention, however, is not limited to this. The attribute of the user terminal 10 may be determined based on the browser or the like of the user terminal 10.

The attribute of the user terminal (portable telephone) 10 is not limited to the country to which the user terminal 10 belongs, but may include a region to which the user terminal 10 belongs. In this case, the Web address conversion tables or databases in which the identification numbers 441 and the Web page address 442 are associated with each other are produced respectively for regions (e.g., a European region, a North American region, and an East Asian region) to which the user terminals 10 belong.

The user terminal 10 is not limited to the portable telephone, but is required only to have the function of being capable of connecting to at least the Internet 20, to have a predetermined browser installed therein, and to comprise an input section for entry of the identification number and the like and a display section for displaying Web content. For example, devices other than the portable telephone which may be used herein include a PDA (Personal Digital Assistant), a personal computer, and a combination of a consumer TV game machine and a television receiver.

While the invention has been described in detail, the foregoing description is in all aspects illustrative and not restrictive. It is understood that numerous other modifications and variations can be devised without departing from the scope of the invention.

What is claimed is:

1. A Web address conversion system for performing a Web address conversion process corresponding to an attribute of a terminal, said Web address conversion system comprising:
a specifying element for specifying an attribute of a terminal from which access is made upon receipt of an access request from said terminal;
a table holding element for holding therein a conversion table produced in corresponding relation to said attribute of said terminal, said conversion table containing an identification number and a Web page address of Web content associated with each other; and
a conversion element, upon receipt of an access request designating said identification number from said terminal, for searching said conversion table corresponding to said attribute of said terminal specified by said specifying element to retrieve a Web page address associated with said identification number, thereby sending a response designating said retrieved Web page address to said terminal from which access is made.

2. A Web address conversion system for performing a Web address conversion process corresponding to an attribute of a portable telephone, said Web address conversion system comprising:
a specifying element for specifying an attribute of a portable telephone from which access is made upon receipt of a Web access request from said portable telephone;
a table holding element for holding therein a conversion table produced in corresponding relation to said attribute of said portable telephone, said conversion table containing an identification number and a Web page address of Web content associated with each other; and
a conversion element, upon receipt of an access request designating said identification number from said portable telephone, for searching said conversion table corresponding to said attribute of said portable telephone specified by said specifying element to retrieve a Web page address associated with said identification number, thereby sending a response designating said retrieved Web page address to said portable telephone from which access is made.

3. The Web address conversion system according to claim 2, wherein
said attribute of said portable telephone is a region to which said portable telephone belongs.

4. The Web address conversion system according to claim 2, wherein
said attribute of said portable telephone is a country to which said portable telephone belongs.

5. The Web address conversion system according to claim 4, wherein
said specifying element specifies the country to which said portable telephone belongs, based on a language used by said portable telephone from which access is made.

6. The Web address conversion system according to claim 2, wherein
upon receipt of an access request designating an identification number with an additional symbol from said portable telephone, the conversion element searches said conversion table corresponding to said additional symbol to retrieve a Web page address associated with said identification number, thereby sending a response designating said retrieved Web page address to said portable telephone from which access is made.

7. A Web address conversion system for performing a Web address conversion process corresponding to an attribute of a portable telephone, said Web address conversion system comprising:
a) a plurality of conversion servers each corresponding to an attribute of a portable telephone, each of said conversion servers including
a-1) a table holding element for holding therein a conversion table produced in corresponding relation to an attribute of a portable telephone, said conversion table containing an identification number and a Web page address of Web content associated with each other, and
a-2) a conversion element, upon receipt of an access request designating said identification number from said portable telephone, for searching said conversion table to retrieve a Web page address associated with said identification number, thereby sending a response designating said retrieved Web page address to said portable telephone from which access is made; and
b) an assignment server including
b-1) a specifying element for specifying an attribute of a portable telephone from which access is made upon receipt of an access request from said portable telephone, and
b-2) an assignment element for designating a Web page address of a corresponding one of said conversion servers which corresponds to said attribute of said portable telephone specified by said specifying element, thereby to assign a destination to which said portable telephone is to be connected to said corresponding one of said conversion servers.

8. A method of performing a Web address conversion process corresponding to an attribute of a portable telephone, said method comprising the steps of:
receiving a Web access request from a portable telephone;
specifying an attribute of said portable telephone from which access is made;
receiving an access request designating an identification number from said portable telephone;
searching a conversion table produced in corresponding relation to the specified attribute of said portable telephone to convert said designated identification number into a Web page address of Web content; and
sending a response designating said Web page address to change a destination to which said portable telephone is to be connected to a Web site corresponding to said Web page address.
